(19) United States
(12) Patent Application Publication
(10) Pub. No.: US 2026/0156663 A1
(43) Pub. Date: Jun. 4, 2026

(54) ENHANCED POSITIONING PROTOCOL FOR CARRIER AGGREGATION BEAM SELECTION

(71) Applicant: Nokia Technologies Oy, Espoo (FI)

(72) Inventors: Oana-Elena BARBU, Aalborg (DK); Ryan KEATING, Naperville, IL (US); Johannes HARREBEK, Aalborg (DK); Benny VEJLGAARD, Aalborg (DK)

(21) Appl. No.: 18/558,789

(22) PCT Filed: May 3, 2022
(86) PCT No.: PCT/EP2022/061797

§ 371 Date: Nov. 3, 2023

Related U.S. Application Data
(60) Provisional application No. 63/185,688, filed on May 7, 2021.

(51) Int. Cl. H04W 72/51; H04B 7/06; H04L 5/00; H04W 24/10; H04W 72/044

(52) U.S. Cl. CPC H04W 72/51; H04B 7/06968; H04L 5/0026; H04L 5/0094; H04W 24/10; H04W 72/044

(57) ABSTRACT

Systems, methods, apparatuses, and computer program products for enhanced positioning protocol for earner aggregation beam selection are provided. A method may include receiving, from a network element, a set of carrier frequencies for a positioning reference signal transmission from a network node. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for enhanced positioning protocol for carrier aggregation beam selection.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IOT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) are named gNB when built on NR technology and named NG-eNB when built on E-UTRAN radio.

### SUMMARY

Some example embodiments may be directed to a method. The method may include receiving, from a network element, a set of carrier frequencies for a positioning reference signal transmission from a network node. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to an apparatus. The apparatus may include at least one processor and at least one memory including computer program code. The at least one memory and computer program code may also be configured to, with the at least one processor, cause the apparatus at least to receive, from a network element, a set of carrier frequencies for a positioning reference signal transmission from a network node. The apparatus may also be caused to receive a request for a beam count per carrier frequency in the set of carrier frequencies. The apparatus may further be caused to report, in response to the request, a table or indexed list including a mapping between a total number of beams and a carrier frequency of the set of carrier frequencies. In addition, the apparatus may be caused to receive information about a selected transmission beam for one of the set of carrier frequencies.

Other example embodiments may be directed to an apparatus. The apparatus may include means for receiving, from a network element, a set of carrier frequencies for a positioning reference signal transmission from a network node. The apparatus may also include means for receiving a request for a beam count per carrier frequency in the set of carrier frequencies. The apparatus may further include means for reporting, in response to the request, a table or indexed list including a mapping between a total number of beams and a carrier frequency of the set of carrier frequencies. In addition, the apparatus may include means for receiving information about a selected transmission beam for one of the set of carrier frequencies.

In accordance with other example embodiments, a non-transitory computer readable medium may be encoded with instructions that may, when executed in hardware, perform a method. The method may include receiving, from a network element, a set of carrier frequencies for a positioning reference signal transmission from a network node. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to a computer program product that performs a method. The method may include receiving, from a network element, a set of carrier frequencies for a positioning reference signal transmission from a network node. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to an apparatus that may include circuitry configured to receive, from a network element, a set of carrier frequencies for a positioning reference signal transmission from a network node. The apparatus may also include circuitry configured to receive a request for a beam count per carrier frequency in the set of carrier frequencies. The apparatus may further include circuitry configured to report, in response to the request, a table or indexed list including a mapping between a total number of beams and a carrier frequency of the set of carrier frequencies. In addition, the apparatus may include circuitry configured to receive information about a selected transmission beam for one of the set of carrier frequencies.

Certain example embodiments may be directed to a method. The method may include receiving, from a network element, a set of carrier frequencies for a positioning reference signal transmission to a user equipment. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to an apparatus. The apparatus may include at least one processor and at least one memory including computer program code. The at least one memory and computer program code may be configured to, with the at least one processor, cause the apparatus at least to receive, from a network element, a set of carrier frequencies for a positioning reference signal transmission to a user equipment. The apparatus may also be caused to receive a request for a beam count per carrier frequency in the set of carrier frequencies. The apparatus may further be caused to report, in response to the request, a table or indexed list including a mapping between a total number of beams and a carrier frequency of the set of carrier frequencies. In addition, the apparatus may be caused to receive information about a selected transmission beam for one of the set of carrier frequencies.

Other example embodiments may be directed to an apparatus. The apparatus may include means for receiving, from a network element, a set of carrier frequencies for a positioning reference signal transmission to a user equipment. The apparatus may also include means for receiving a request for a beam count per carrier frequency in the set of carrier frequencies. The apparatus may further include means for reporting, in response to the request, a table or indexed list including a mapping between a total number of beams and a carrier frequency of the set of carrier frequencies. In addition, the apparatus may include means for receiving information about a selected transmission beam for one of the set of carrier frequencies.

In accordance with other example embodiments, a non-transitory computer readable medium may be encoded with instructions that may, when executed in hardware, perform a method. The method may include receiving, from a network element, a set of carrier frequencies for a positioning reference signal transmission to a user equipment. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to a computer program product that performs a method. The method may include receiving, from a network element, a set of carrier frequencies for a positioning reference signal transmission to a user equipment. The method may also include receiving a request for a beam count per carrier frequency in the set of carrier frequencies. The method may further include reporting, in response to the request, a table or indexed list including a mapping between a total number of beams and a carrier frequency of the set of carrier frequencies. In addition, the method may include receiving information about a selected transmission beam for one of the set of carrier frequencies.

Other example embodiments may be directed to an apparatus that may include circuitry configured to receive, from a network element, a set of carrier frequencies for a positioning reference signal transmission to a user equipment. The apparatus may also include circuitry configured to receive a request for a beam count per carrier frequency in the set of carrier frequencies. The apparatus may further include circuitry configured to report, in response to the request, a table or indexed list including a mapping between a total number of beams and a carrier frequency of the set of carrier frequencies. In addition, the apparatus may include circuitry configured to receive information about a selected transmission beam for one of the set of carrier frequencies.

Some example embodiments may be directed to a method. The method may include selecting a set of carrier frequencies for a positioning reference signal transmission from a network node to a user equipment. The method may also include requesting a beam count per carrier frequency in the set of carrier frequencies from the network node and the user equipment. The method may further include selecting a subset of carrier frequencies to measure the positioning reference signal transmission on. In addition, the method may include receiving a report of positioning reference signal measurements from the user equipment. Further, the method may include applying the report and a cross-carrier beam mapping to select a network node transmission beam to be used for the positioning reference signal transmission. The method may also include transmitting information to the network node and the user equipment about a selected transmission beam for the set of carrier frequencies.

Other example embodiments may be directed to an apparatus. The apparatus may include at least one processor and at least one memory including computer program code. The at least one memory and computer program code may also be configured to, with the at least one processor, cause the apparatus at least to select a set of carrier frequencies for a positioning reference signal transmission from a network node to a user equipment. The apparatus may also be caused to request a beam count per carrier frequency in the set of carrier frequencies from the network node and the user equipment. The apparatus may further be caused to select a subset of carrier frequencies to measure the positioning reference signal transmission on. In addition, the apparatus may be caused to receive a report of positioning reference signal measurements from the user equipment. Further, the apparatus may be caused to apply the report and a cross-carrier beam mapping to select a network node transmission beam. The apparatus may also be caused to transmit to the network node and the user equipment information about a selected transmission beam for the set of carrier frequencies.

Other example embodiments may be directed to an apparatus. The apparatus may include means for selecting a set of carrier frequencies for a positioning reference signal transmission from a network node to a user equipment. The apparatus may also include means for requesting a beam count per carrier frequency in the set of carrier frequencies from the network node and the user equipment. The apparatus may further include means for selecting a subset of carrier frequencies to measure the positioning reference signal transmission on. In addition, the apparatus may include means for receiving a report of positioning reference signal measurements from the user equipment. Further, the apparatus may include means for applying the report and a cross-carrier beam mapping to select a network node transmission beam to be used for the positioning reference signal transmission. The apparatus may also include means for transmitting to the network node and the user equipment information about a selected transmission beam for the set of carrier frequencies.

In accordance with other example embodiments, a non-transitory computer readable medium may be encoded with instructions that may, when executed in hardware, perform a method. The method may include selecting a set of carrier frequencies for a positioning reference signal transmission from a network node to a user equipment. The method may also include requesting a beam count per carrier frequency in the set of carrier frequencies from the network node and the user equipment. The method may further include selecting a subset of carrier frequencies to measure the positioning reference signal transmission on. In addition, the method may include receiving a report of positioning reference signal measurements from the user equipment. Further, the method may include applying the report and a cross-carrier beam mapping to select a network node transmission beam to be used for the positioning reference signal transmission. The method may also include transmitting information to the network node and the user equipment about a selected transmission beam for the set of carrier frequencies.

Other example embodiments may be directed to a computer program product that performs a method. The method may include selecting a set of carrier frequencies for a positioning reference signal transmission from a network node to a user equipment. The method may also include requesting a beam count per carrier frequency in the set of carrier frequencies from the network node and the user equipment. The method may further include selecting a subset of carrier frequencies to measure the positioning reference signal transmission on. In addition, the method may include receiving a report of positioning reference signal measurements from the user equipment. Further, the method may include applying the report and a cross-carrier beam mapping to select a network node transmission beam to be used for the positioning reference signal transmission. The method may also include transmitting information to the network node and the user equipment about a selected transmission beam for the set of carrier frequencies.

Other example embodiments may be directed to an apparatus that may include circuitry configured to select a set of carrier frequencies for a positioning reference signal transmission from a network node to a user equipment. The apparatus may also include circuitry configured to request a beam count per carrier frequency in the set of carrier frequencies from the network node and the user equipment. The apparatus may further include circuitry configured to select a subset of carrier frequencies to measure the positioning reference signal transmission on. In addition, the apparatus may include circuitry configured to receive a report of positioning reference signal measurements from the user equipment. Further, the apparatus may include circuitry configured to apply the report and a cross-carrier beam mapping to select a network node transmission beam. The apparatus may also include circuitry configured to transmit to the network node and the user equipment information about a selected transmission beam for the set of carrier frequencies.

### BRIEF DESCRIPTION OF THE DRAWINGS

For proper understanding of example embodiments, reference should be made to the accompanying drawings, wherein:

FIG. 1(a) illustrates an example transmission reception point-user equipment (TRP-UE) beam pair for operation at carrier C1, according to certain example embodiments.

FIG. 1(b) illustrates another example TRP-UE beam pair for operation at carrier C2, according to certain example embodiments.

FIG. 2 illustrates an example report table, according to certain example embodiments.

FIG. 3(a) illustrates an example UE capability across carriers, according to certain example embodiments.

FIG. 3(b) illustrates another example of UE beam capabilities across carriers, according to certain example embodiments.

FIG. 4 illustrates an example TRP-UE beam selection signal diagram, according to certain example embodiments.

FIG. 5 illustrates an example flow diagram of a method, according to certain example embodiments.

FIG. 6 illustrates an example flow diagram of another method, according to certain example embodiments.

FIG. 7 illustrates an example flow diagram of a further method, according to certain example embodiments.

FIG. 8(a) illustrates an apparatus, according to certain example embodiments.

FIG. 8(b) illustrates another apparatus, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for enhanced LTE positioning protocol for carrier aggregation beam selection.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Certain solutions have been provided to enable radio access technology (RAT) dependent (for both frequency range 1 (FR1) and frequency range 2 (FR2)) and RAT independent NR positioning enhancements for improving positioning accuracy, latency, network and/or device efficiency. For instance, certain methods, measurements, signaling, and procedures have been specified to improve positioning accuracy of Rel-16 NR positioning methods by mitigating UE reception/transmission (Rx/Tx) and/or gNB Rx/Tx timing delays, including (RAN1) downlink (DL), uplink (UL), and DL+UL positioning methods. The mitigation may also include UE-based and UE-assisted positioning solutions. Additionally, the procedure, measurements, reporting, and signaling for improving the accuracy of RAN1 may include, for example, UL angle of arrival (AoA) for network-based positioning solutions, and DL-angle of departure (AoD) for UE-based and network-based (including UE-assisted) positioning solutions.

Certain enhancements may be beneficial for the purpose of improving positioning, accuracy, reducing latency, improving network and/or device efficiency. Such enhancements may include simultaneous transmission by the gNB and aggregated reception by the UE of intra-band one or more contiguous carriers in one or more contiguous positioning frequency layers (PFLs). In addition, enhancements may include simultaneous transmission by the UE and aggregated reception by the gNB of the sounding reference signal (SRS) for positioning in multiple contiguous intra-band carriers.

In some cases, cellular-based positioning accuracy may have certain challenges. For instance, cellular-based positioning accuracy may experience limited available bandwidth. Further, higher SNR and wider bandwidth may result in more accurate ranging. Thus, a large bandwidth may achieve high accuracy.

As defined in 3^{rd} Generation Partnership Project (3GPP), positioning reference signals (PRS) may be defined as a specific type of reference signal. However, certain example embodiments described herein may be applicable to PRS as well as other types of reference signals used for positioning. PRS on multiple carriers and from multiple transmission reception points (TRPs) may complicate the UE handling of the antenna and beam selection per TRP per carrier. This may occur as bands may have a different beam and antenna configuration, even across FR1 and FR2 bands. Furthermore, selecting the UE-TRP beams and respective antenna configurations may be performed via standard synchronization signal blocks (SSBs) and PRS exhaustive scanning procedures. However, an issue may arise in these procedures in that the time to obtain beam alignment may be long, and current consumption may be heavy. Thus, certain example embodiments may address at least the problem of high positioning latency due to exhaustive beam sweeping in a carrier aggregation (CA) PRS scenario.

Certain example embodiments may target enhancements to LTE positioning protocol (LPP) to enable CA positioning in either UL or DL. In doing so, certain example embodiments may provide an LPP signaling framework that enables beam selection across carriers with minimal signaling and processing overhead. For instance, certain example embodiments may provide a framework that describes how the TRP-UE beam pairs across carriers are selected for a CA-LPP session without performing a full TX-RX beam sweep for the carrier.

According to certain example embodiments, a location management function (LMF) may select C={C1, . . . , CX} carrier frequencies for PRS transmission from a selected TRP to a target UE. In some example embodiments, the C carriers may be selected from different carrier sets that span diverse frequency ranges including, for example, FR1, FR2, and beyond frequency bands.

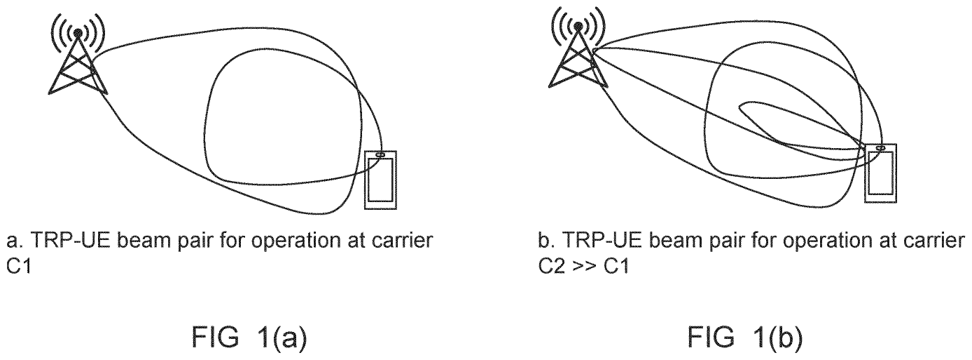

FIG. 1(a) illustrates an example TRP-UE beam pair for operation at carrier C1, according to certain example embodiments. In addition, FIG. 1(b) illustrates another example TRP-UE beam pair for operation at carrier C2, according to certain example embodiments. illustrates an example of TRP-UE beam pairs across carriers, according to certain example embodiments. In certain example embodiments, the TRP may select C TX beams to point to the UE, and similarly, the UE may select C RX beams to optimally receive the C different beamed PRS. To avoid exhaustive beam sweeping at the communication end, the LMF may coordinate the beam selection of the TRP and the UE.

For instance, in certain example embodiments, the LMF may ask the TRP and the UE for a beam count per carrier. In some example embodiments, the LMF may request the TRP and the UE to respectively report the number of distinct beams it can generate per carrier C={C1, . . . , CX}. According to certain example embodiments, this value may depend on the antenna architecture and beamforming capabilities of the TRP and the UE. However, the number of distinct beams may be a fixed value via a predefined codebook. In certain example embodiments, the number of distinct beams may not be the number of useful beams (i.e., beams per carrier pointing towards a TRP), but may be the total number of beams the UE can form to cover the entire angular space at all directions.

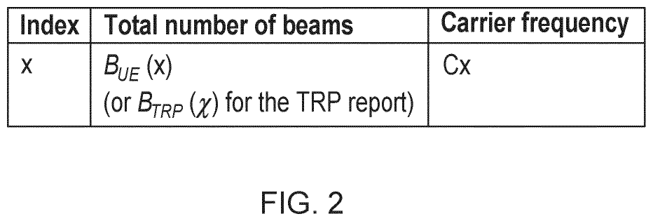

FIG. 2 illustrates an example report table, according to certain example embodiments. In particular, according to certain example embodiments, the TRP and the UE may report a table (e.g., FIG. 2) with a mapping between the total number of beams and the carrier frequency. In other example embodiments, the LMF may use the latency specifications for the target UE and the reported table to select a subset of carriers for a first round of measurements, F1∈C. In some example embodiments, the subset may include a single carrier. For example, in certain example embodiments, if the UE has certain latency specifications, the LMF may select the carrier C(ĉ) that minimizes ĉ=arg min(B_{UE}(c)+B_{TRP}(c), c=1:X), where B_{UE}(c) is the number of UE beams for carrier frequency c.

According to certain example embodiments, the LMF may instruct the UE and the TRP to initiate channel sounding for the current positioning session. For instance, at a frequency in the set F1, the UE may be instructed to measure at least the delays and AOA/AOD of the most relevant L>=1 channel taps for the beamed PRS. The UE may then report an LPP report including at least a beamed PRS index, a UE RX beam index, and [(AOA/AOD, delay)(1), . . . , (AOA/AOD, delay)(L)].

In certain example embodiments, the LMF may use the report and a TRP cross-carrier beam mapping method (TRP-CCBM) to select TRP TX beams to be used for PRS transmission and/or configuration over the C frequencies for the respective UE. According to certain example embodiments, such beam selection across carriers may be performed on a per UE basis, using the explicit reporting from the report described above. According to other example embodiments, depending on the LMP implementation, the LMF may combine reports from nearby UEs and jointly select the relevant PRS beams.

According to certain example embodiments, the LMF may inform the TRP and the UE about the PRS TX beams for carriers C using the outcome of the TRP TX beam selection described above. In some example embodiments, the gNB/LMF may have a new quasi-colocation (QCL) type (i.e., QCL-Type-E), which may tell the UE that it can assume that the same RX beam will work for two PRS in different carriers, or that the TX beam is nested inside of the other one in the spatial domain. According to certain example embodiments, this may apply to both the serving gNB and the neighboring gNBs. In addition, the gNBs may inform the LMF of the QCL relationship between carriers when reporting the PRS configurations.

In certain example embodiments, the UE may use its own measurement and an internal UE cross-carrier beam mapping (UE-CCBM) to select the RX beams for reception over unmeasured carriers (i.e., carries in the set of C\F1). Furthermore, having selected the beam pairs for a carrier in C, the LPP session may continue according to standard procedure.

As noted above, certain example embodiments may provide an LPP signaling framework to enable fast beam selection across different positioning carrier frequencies. For instance, certain example embodiments may provide a framework that describes how the TRP-UE beam pairs across carriers may be selected for an LPP session without performing a full TX-RX beam sweep for a carrier.

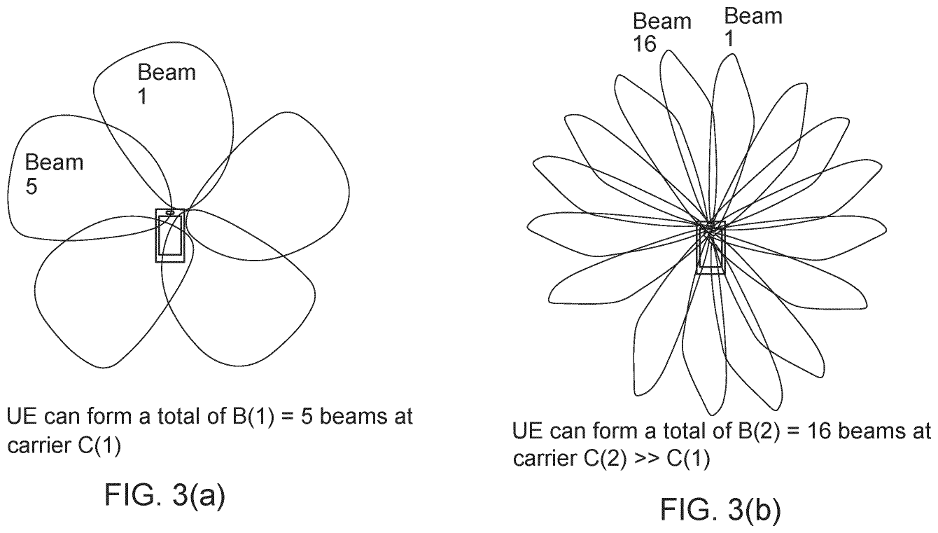

FIG. 3(a) illustrates an example UE capability across carriers, according to certain example embodiments. Further, FIG. 3(b) illustrates another example of UE beam capabilities across carriers, according to certain example embodiments. In particular, according to some example embodiments, a UE that may utilize localization may be equipped with R antennas and able to form G (x) beams per carrier frequency C(x)∈{C(1), . . . , C(X)} as illustrated in the examples of FIGS. 3(a) and 3(b). Here, the LMF may select a set of TRPs to send beamed PRS towards the target UE on X carriers. Similarly, a TRP may form P(x) beams per carrier frequency C(x).

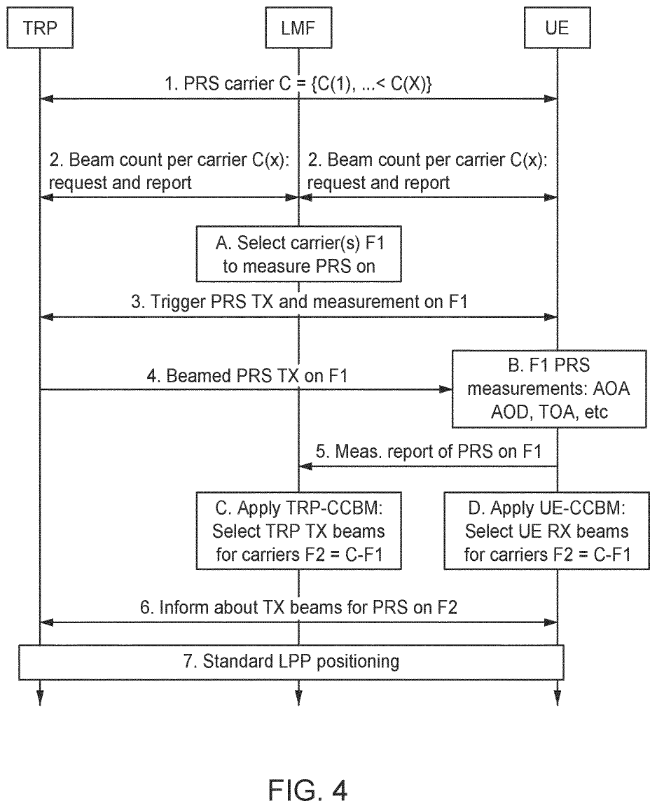

According to certain example embodiments, unless there is some degree of coordination about which beams of the communication ends may use, the UE may perform an exhaustive beam sweep across its beams B (x) and across the carrier frequencies C(x), x=1:X, to measure the PRS transmitted with TRP beams P(x). In some instances, this operation may be heavy at the UE-side, and may also introduce unacceptable latency. Thus, to avoid the latency and computational costs, certain example embodiments may provide a signaling framework through which the LMF may coordinate the TRP-UE beam selection across carriers as shown in the example of FIG. 4.

FIG. 4 illustrates an example TRP-UE beam selection signal diagram, according to certain example embodiments. At step 1, the LMF may select C={C1, . . . , CX} carrier frequencies for the PRS transmission from a selected TRP to a target UE. At step 2, after selecting a set C={C1, . . . , CX} of PRS carriers, the LMF may request a beam count per carrier from selected TRPs and the target UE. According to certain example embodiments, the beam count may represent the number of beams to cover the entire angular space, when operating at the selected carriers. In certain example embodiments, entities (TRPs and UE) may report their capabilities in, for example, the form of a table (e.g., FIG. 3) or an indexed list. In one example embodiment, the indexed list may include Bue={Bue(1), . . . , Btrp(X)}, where Bue(x) is the total number of UE beams at carrier C(x). For example, with respect to the example of FIGS. 3(a) and 3(b), the UE may report: B (1)=5, B (2)=16. In another example embodiment, the indexed list may also include Btrp={Btrp(1), . . . , Btrp(X)}, where Btrp(x) is the total number of TRP beams at carrier C(x).

At process A, using Bue, Btrp(of the selected TRPs) and the latency and/or accuracy specifications, the LMF may select a small subset of PRS carriers, F1∈C subject to a full beam sweep at both TRP and UE sides. For instance, according to certain example embodiments, in one implementation, the LMF may select a single carrier F1={C(c)}, where index c may be selected so that the following expression can be satisfied:

$$c = arg {min}_{j} ( Bue ( j ) + {\sum }_{a = 1 : A} {Btrp}_{a} ( j ) , j = 1 \text{:} X ) .$$

At step 3, the LMF may communicate the subset F1 to both the TRP and the UE, and the standard beam PRS transmission and measurement may follow. At step 4, the TRP may transmit a beamed PRS TX on F1 to the UE. At process B and step 5, the UE may be instructed to respectively obtain measurements and to report certain estimates for the TX-RX beam pair (at the carrier in F1). In certain example embodiments, the estimates may include a delay of the most relevant D channel taps (D-given by the LMF. The estimates may also include AOA/AOD of the same taps. In addition, the estimates may include signal-to-noise ratio (SNR), reference signal received power (RSRP), time of arrival (TOA), and others. These estimates may be identified as the estimated beamed-channel (EBC). For example, the EBC (a, b, f) may include measurements related to any of the three example estimates described above for the channel formed by the a-th TRP TX beam index and the b-th UE RX beam index when operating at carrier f∈F1.

According to certain example embodiments, at process C, upon reception of EBC(a,b,f), ∀f∈F1, ∀a∈1̅:̅B̅t̅r̅p̅(̅f̅)̅, ∀b∈1̅:̅B̅u̅e̅(̅f̅)̅, the LMF may apply a TRP specific cross-carrier beam mapping (TRP-CCBM) to select the TRP TX beam indices for unobserved carriers c∈C\F1. Similarly, at process D, the UE may apply a UE specific cross-carrier beam mapping (UE-CCBM) to select the UE RX beams for unobserved carriers d∈C\F1. At step 6, the LMF may forward the selected TX indices to the TRP and the UE. That is, the LMF may inform the TRP and the UE about the PRX TX beams for carriers C. At step 7, having selected the beam pairs for the carrier in C, the LPP session may continue according to standard LPP positioning.

According to certain example embodiments, TRP-CCBM may use the reported EBC and predict the channels at the unobserved carriers. In some example embodiments, the LMF may combine EBC reports for different TRPs reported by the same UE, and perform a CCBM mapping across carriers and across TRPs. These may be various CCBM implementations, and may be LMF specific. For example, as shown in process D, the UE may use its own UE-CCBM and the EBC (a,b,f) and select the UE RX beam indices to be used for reception of the unobserved carriers d∈C\F1.

According to certain example embodiments, the CCBM methods may not be part of the standard LPP. They may, however, be implemented with state-of-art channel/beam predictors. For example, in certain example embodiments, a CCBM method may use for the pair (a,b), {EBC (a,b,f), ∀f∈F1} as input to a machine learning regressor (e.g. a ResNet neural network) that outputs a predicted EBC for the beam pair (g,h) at carrier d (i.e. pEBC(g,h,d), d∈C\F1) or alternatively a predicted TOA (i.e. pTOA(g,h,d)). Then, the predicted metrics may be used to select the best (t1,r1) pair for the unobserved frequency d, as shown in the following example expression:

$${( , )}_{d} = arg max ( f ( pEBC ( g , h , d ) ) , ∀ g ∈ \overline{1 \text{:} Btrp ( d )} , ∀ h ∈ \overline{1 \text{:} Bue ( d )} ) ,$$

where the function f( ) may combine the metrics in pEBC or select one including, for example, SNR. According to certain example embodiments, a CCBM may include a tabulated mapping which uses the measurements of F1 beams and extrapolates them to C\F1 beams via applying one or more correction term/factors.

According to certain example embodiments, in process A and step 3, the LMF may also determine a new QCL-Type (e.g., QCL-Type-E) which informs the UE that it may make some assumptions about the RX and TX beams which apply across carriers. For example, the LMF/gNBs may know that certain PRS beams in carrier b are nested in carrier a (i.e., spatially the beams from b point within the beam shape of a). This may give the UE the ability to consider a similar RX beam for receiving that PRS beam in carrier b as the beam in carrier a which is QCL-Type-E. In certain example embodiments, the LMF may know at a minimum, the maximum radiated power direction (i.e., DL-AoD) of the DL PRS. In other example embodiments, the gNBs/TRPs themselves may inform the LMF which PRS beams across carriers are QCL-Type-E. This may be done with new NR positioning protocol a (NRPPa) signaling.

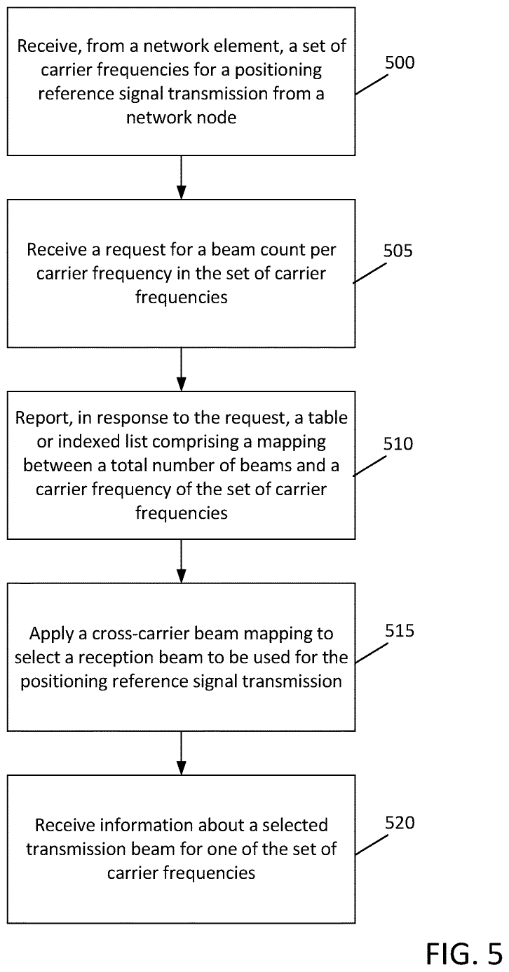

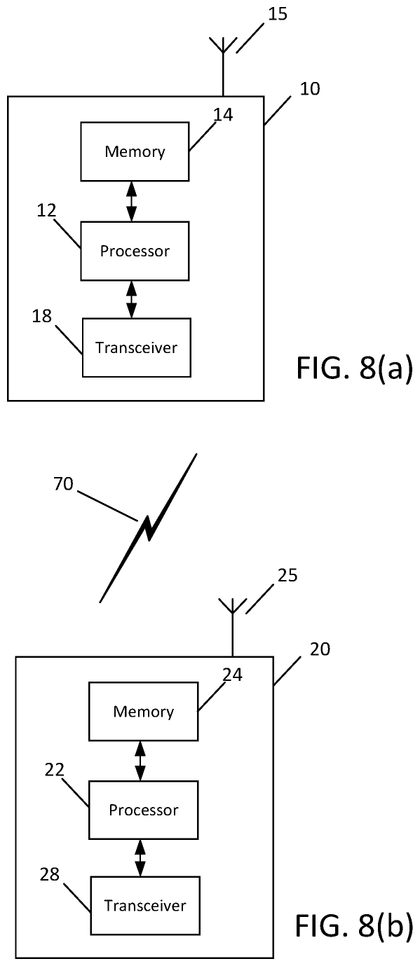

FIG. 5 illustrates an example flow diagram of a method, according to certain example embodiments. In an example embodiment, the method of FIG. 5 may be performed by a network entity, network node, or a group of multiple network elements in a 3GPP system, such as LTE or 5G-NR. For instance, in an example embodiment, the method of FIG. 5 may be performed by a UE, for instance, similar to apparatus 10 illustrated in FIG. 8(a) or 8(b).

According to certain example embodiments, the method of FIG. 5 may include, at 500, receiving, from a network element, a set of carrier frequencies for a positioning reference signal transmission from a network node. At 505, the method may include receiving a request for a beam count per carrier frequency in the set of carrier frequencies. At 510, the method may include reporting, in response to the request, a table or indexed list comprising a mapping between a total number of beams and a carrier frequency of the set of carrier frequencies. At 515, the method may include applying a cross-carrier beam mapping to select a reception beam to be used for the positioning reference signal transmission. At 520, the method may include receiving information about a selected transmission beam for one of the set of carrier frequencies.

According to certain example embodiments, the method may also include measuring at least one of a delay of a relevant channel tap, an angle of arrival or an angle of departure of the relevant channel tap, a time of arrival, a signal-to-noise ratio, or a reference signal received power for the position reference transmission. In certain example embodiments, the method may also include transmitting, to the network element, a report of the measurement made in response to the instruction. In some example embodiments, the method may further include, in response to the request for the beam count, reporting a number of distinct beams that can be generated per carrier frequency of the set of carrier frequencies. In other example embodiments, the number of distinct beams may be a fixed number via a predefined codebook.

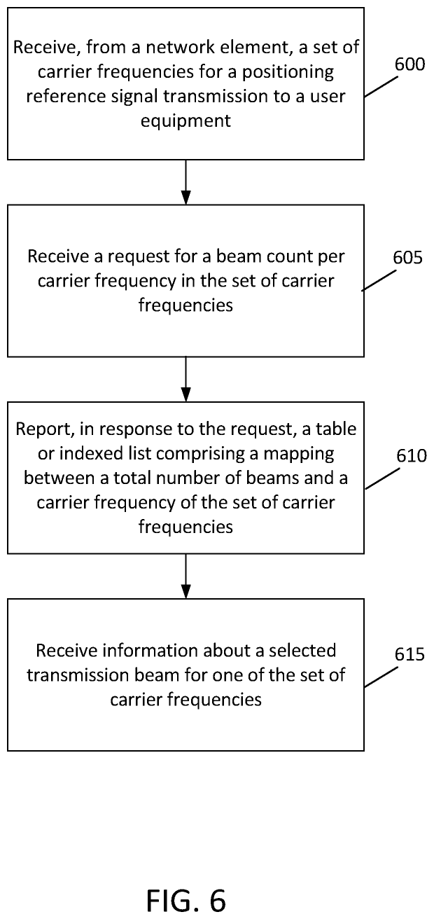

FIG. 6 illustrates an example flow diagram of another method, according to certain example embodiments. In an example embodiment, the method of FIG. 6 may be performed by a network entity, network node, or a group of multiple network elements in a 3GPP system, such as LTE or 5G-NR. For instance, in an example embodiment, the method of FIG. 6 may be performed by a network node such as, for example, a BS or TRP, for instance, similar to apparatus 20 illustrated in FIG. 8(a) or 8(b).

According to certain example embodiments, the method of FIG. 6 may include, at 600, receiving, from a network element, a set of carrier frequencies for a positioning reference signal transmission to a user equipment. At 605, the method may include receiving a request for a beam count per carrier frequency in the set of carrier frequencies. At 610, the method may include reporting, in response to the request, a table or indexed list including a mapping between a total number of beams and a carrier frequency of the set of carrier frequencies. At 615, the method may include receiving information about a selected transmission beam for one of the set of carrier frequencies.

According to certain example embodiments, the method may also include transmitting the positioning reference signal transmission to the user equipment. According to other example embodiments, the method may include, in response to the request for the beam count, reporting a number of distinct beams that can be generated per carrier frequency of the set of carrier frequencies. According to some example embodiments, the number of distinct beams may be a fixed number via a predefined codebook.

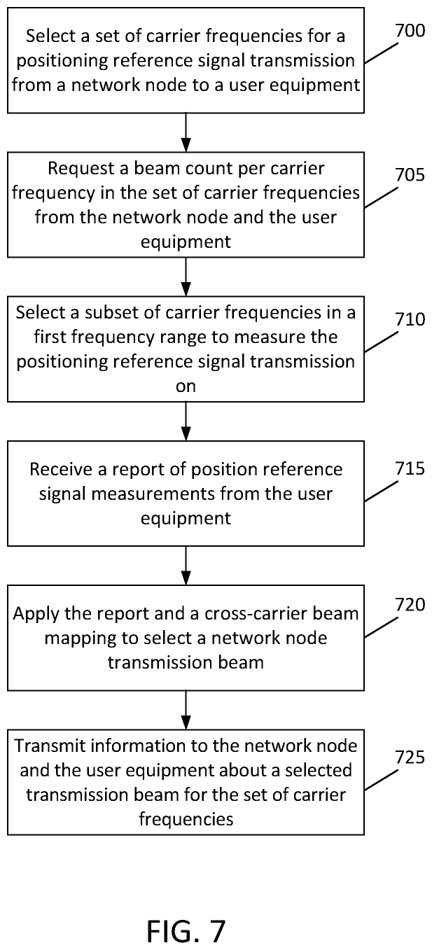

FIG. 7 illustrates an example flow diagram of another method, according to certain example embodiments. In an example embodiment, the method of FIG. 7 may be performed by a network entity, network node, or a group of multiple network elements in a 3GPP system, such as LTE or 5G-NR. For instance, in an example embodiment, the method of FIG. 7 may be performed by a network element such as, for example, an LMF, for instance, similar to apparatus 20 illustrated in FIG. 8(a) or 8(b).

According to certain example embodiments, the method of FIG. 7 may include, at 700, selecting a set of carrier frequencies for a positioning reference signal transmission from a network node to a user equipment. At 705, the method may include requesting a beam count per carrier frequency in the set of carrier frequencies from the network node and the user equipment. At 710, the method may include selecting a subset of carrier frequencies to measure the positioning reference signal transmission on. At 715, the method may include receiving a report of positioning reference signal measurements from the user equipment. At 720, the method may include applying the report and a cross-carrier beam mapping to select a network node transmission beam to be used for the positioning reference signal transmission. At 725, the method may include transmitting information to the network node and the user equipment about a selected transmission beam for the set of carrier frequencies.

According to certain example embodiments, the set of carrier frequencies may be selected from different carrier sets that span diverse frequency ranges. According to other example embodiments, the beam count represents a number of beams to cover an entire angular space when operating at a carrier frequency. According to some example embodiments, the method may also include instructing the user equipment and the network node to initiate channel sounding for a current positioning session. In other example embodiments, selection of the network node transmission beam to be used may be performed on a per user equipment basis using the report of positioning reference signal measurements. According to certain example embodiments, the method may further include combining reports of positioning reference signal measurements from a plurality of other user equipment, and jointly selecting relevant positioning reference signal transmissions based on the combined reports. According to other example embodiments, the method may further include determining a quasi-colocation type, and informing, based on the quasi-colocation type, the user equipment that a positioning reference signal transmission of one carrier frequency is nested in a second carrier frequency.

FIG. 8(a) illustrates an apparatus 10 according to certain example embodiments. In certain example embodiments, apparatus 10 may be a node or element in a communications network or associated with such a network, such as a UE, mobile equipment (ME), mobile station, mobile device, stationary device, or other similar device. It should be noted that one of ordinary skill in the art would understand that apparatus 10 may include components or features not shown in FIG. 8(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 8(a).

As illustrated in the example of FIG. 8(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 8(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-5.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-5.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element, a set of carrier frequencies for a positioning reference signal transmission from a network node. Apparatus 10 may also be controlled by memory 14 and processor 12 to receive a request for a beam count per carrier frequency in the set of carrier frequencies. Apparatus 10 may further be controlled by memory 14 and processor 12 to report, in response to the request, a table or indexed list including a mapping between a total number of beams and a carrier frequency of the set of carrier frequencies. Apparatus 10 may also be controlled by memory 14 and processor 12 to apply a cross-carrier beam mapping to select a reception beam to be used for the positioning reference signal transmission. In addition, apparatus 10 may be controlled by memory 14 and processor 12 to receive information about a selected transmission beam for one of the set of carrier frequencies.

FIG. 8(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), NM, BS, LMF, and/or WLAN access point, associated with a radio access network (RAN), such as an LTE network, 5G or NR. It should be noted that one of ordinary skill in the art would understand that apparatus 20 may include components or features not shown in FIG. 8(b).

As illustrated in the example of FIG. 8(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-4, 6, and 7.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-4, 6, and 7.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

In other example embodiments, apparatus 20 may be controlled by memory 24 and processor 22 to receive, from a network element, a set of carrier frequencies for a positioning reference signal transmission to a user equipment. Apparatus 20 may also be controlled by memory 24 and processor 22 to receive a request for a beam count per carrier frequency in the set of carrier frequencies. Apparatus 20 may further be controlled by memory 24 and processor 22 to report, in response to the request, a table or indexed list including a mapping between a total number of beams and a carrier frequency of the set of carrier frequencies. In addition, apparatus 20 may be controlled by memory 24 and processor 22 to receive information about a selected transmission beam for one of the set of carrier frequencies.

In other example embodiments, apparatus 20 may be controlled by memory 24 and processor 22 to select a set of carrier frequencies for a positioning reference signal transmission from a network node to a user equipment. Apparatus 20 may also be controlled by memory 24 and processor 22 to request a beam count per carrier frequency in the set of carrier frequencies from the network node and the user equipment. Apparatus 20 may further be controlled by memory 24 and processor 22 to select a subset of carrier frequencies to measure the positioning reference signal transmission on. In addition, apparatus 20 may be controlled by memory 24 and processor 22 to receive a report of positioning reference signal measurements from the user equipment. Further, apparatus 20 may be controlled by memory 24 and processor 22 to apply the report and a cross-carrier beam mapping to select a network node transmission beam. Apparatus 20 may also be controlled by memory 24 and processor 22 to transmit information to the network node and the user equipment about a selected transmission beam for the set of carrier frequencies.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for receiving, from a network element, a set of carrier frequencies for a positioning reference signal transmission from a network node. The apparatus may also include means for means for receiving a request for a beam count per carrier frequency in the set of carrier frequencies. The apparatus may further include means for reporting, in response to the request, a table or indexed list including a mapping between a total number of beams and a carrier frequency of the set of carrier frequencies. In addition, the apparatus may include means for applying a cross-carrier beam mapping to select a reception beam to be used for the PRS transmission. The apparatus may also include means for receiving information about a selected transmission beam for one of the set of carrier frequencies.

Other example embodiments may be directed to an apparatus that includes means for receiving, from a network element, a set of carrier frequencies for a positioning reference signal transmission to a user equipment. The apparatus may also include means for receiving a request for a beam count per carrier frequency in the set of carrier frequencies. The apparatus may further include means for reporting, in response to the request, a table or indexed list including a mapping between a total number of beams and a carrier frequency of the set of carrier frequencies. In addition, the apparatus may include means for receiving information about a selected transmission beam for one of the set of carrier frequencies.

Other example embodiments may be directed to an apparatus that includes means for selecting a set of carrier frequencies for a positioning reference signal transmission from a network node to a user equipment. The apparatus may also include means for requesting a beam count per carrier frequency in the set of carrier frequencies from the network node and the user equipment. The apparatus may further include means for selecting a subset of carrier frequencies to measure the positioning reference signal transmission on. In addition, the apparatus may include means for receiving a report of positioning reference signal measurements from the user equipment. Further, the apparatus may include means for applying the report and a cross-carrier beam mapping to select a network node transmission beam to be used for the positioning reference signal transmission. The apparatus may also include means for transmitting information to the network node and the user equipment about a selected transmission beam for the set of carrier frequencies.

Certain example embodiments described herein provide several technical improvements, enhancements, and/or advantages. In some example embodiments, it may be possible to achieve lower latency and complexity compared to the standard exhaustive beam sweeping. According to other example embodiments, it may be possible to provide flexibility, allowing trading off latency for performance via the selection of the initial measurement set F1. In addition, as noted above certain example embodiments, it may be possible to improve positioning accuracy, reduce latency, and improve network and/or device efficiency. It may also be possible to enable fast beam selection across different positioning carrier frequencies. Other example embodiments may provide a framework that enables selection of TRP-UE beam pairs across carriers for an LPP session without performing a full TX-RX beam sweep for the carrier.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations for implementing the functionality of an example embodiment may be performed as routine(s), which may be implemented as added or updated software routine(s). In one example, software routine(s) may be downloaded into the apparatus

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
BS Base Station
DL Downlink
eNB Enhanced Node B
gNB 5G or Next Generation NodeB
LTE Long Term Evolution
NR New Radio
RA Random Access
RedCap Reduced Capability
RLM Radio Link Monitoring
RRC Radio Resource Control
RRM Radio Resource Management
RSRP Reference Signals Received Power
SDT Small Data Transmission
UE User Equipment
UL Uplink

1-17. (canceled)

18. An apparatus, comprising:
at least one processor; and
at least one memory comprising computer program code,
the at least one memory and the computer program code are configured, with the at least one processor, to cause the apparatus at least to
receive, from a network element, a set of carrier frequencies for a positioning reference signal transmission from a network node;
receive a request for a beam count per carrier frequency in the set of carrier frequencies;
report, in response to the request, a table or indexed list comprising a mapping between a total number of beams and a carrier frequency of the set of carrier frequencies; and
receive information about a selected transmission beam for one of the set of carrier frequencies.

19. The apparatus according to claim 18, wherein the at least one memory and the computer program code are further configured, with the at least one processor, to cause the apparatus at least to:
apply a cross-carrier beam mapping to select a reception beam to be used for the positioning reference signal transmission.

20. The apparatus according to claim 18, wherein the at least one memory and the computer program code are further configured, with the at least one processor, to cause the apparatus at least to:
measure at least one of a delay of a relevant channel tap, an angle of arrival or an angle of departure of the relevant channel tap, a time of arrival, a signal-to-noise ratio, or a reference signal received power for the positioning reference signal transmission.

21. The apparatus according to claim 20, wherein the at least one memory and the computer program code are further configured, with the at least one processor, to cause the apparatus at least to:
transmit, to the network element, a report of the measurement made in response to the instruction.

22. The apparatus according to claim 18, wherein the at least one memory and the computer program code are further configured, with the at least one processor, to cause the apparatus at least to:
in response to the request for the beam count, report a number of distinct beams that can be generated per carrier frequency of the set of carrier frequencies.

23. The apparatus according to claim 22, wherein the number of distinct beams is a fixed number via a predefined codebook.

24. An apparatus, comprising:
at least one processor; and
at least one memory comprising computer program code,
the at least one memory and the computer program code are configured, with the at least one processor, to cause the apparatus at least to
receive, from a network element, a set of carrier frequencies for a positioning reference signal transmission to a user equipment;
receive a request for a beam count per carrier frequency in the set of carrier frequencies;
report, in response to the request, a table or indexed list comprising a mapping between a total number of beams and a carrier frequency of the set of carrier frequencies; and
receive information about a selected transmission beam for one of the set of carrier frequencies.

25. The apparatus according to claim 24, wherein the at least one memory and the computer program code are further configured, with the at least one processor, to cause the apparatus at least to:
transmit the positioning reference signal transmission to the user equipment on a first frequency range.

26. The apparatus according to claim 24, wherein the at least one memory and the computer program code are further configured, with the at least one processor, to cause the apparatus at least to:
in response to the request for the beam count, report a number of distinct beams that can be generated per carrier frequency of the set of carrier frequencies.

27. The apparatus according to claim 26, wherein the number of distinct beams is a fixed number via a predefined codebook.

28. An apparatus, comprising:
at least one processor; and
at least one memory comprising computer program code,
the at least one memory and the computer program code are configured, with the at least one processor, to cause the apparatus at least to
select a set of carrier frequencies for a positioning reference signal transmission from a network node to a user equipment;
request a beam count per carrier frequency in the set of carrier frequencies from the network node and the user equipment;
select a subset of carrier frequencies to measure the positioning reference signal transmission on;
receive a report of positioning reference signal measurements from the user equipment;
apply the report and a cross-carrier beam mapping to select a network node transmission beam; and
transmit to the network node and the user equipment information about a selected transmission beam for the set of carrier frequencies.

29. The apparatus according to claim 28, wherein the set of carrier frequencies is selected from different carrier sets that span diverse frequency ranges.

30. The apparatus according to claim 28, wherein the beam count represents a number of beams to cover an entire angular space when operating at a carrier frequency.

31. The apparatus according to claim 28, wherein the at least one memory and the computer program code are further configured, with the at least one processor, to cause the apparatus at least to:
instruct the user equipment and the network node to initiate channel sounding for a current positioning session.

32. The apparatus according to claim 28, wherein selection of the network node transmission beam to be used is performed on a per user equipment basis using the report of positioning reference signal measurements.

33. The apparatus according to claim 28, wherein the at least one memory and the computer program code are further configured, with the at least one processor, to cause the apparatus at least to:
combine reports of positioning reference signal measurements from a plurality of other user equipment; and
jointly select relevant positioning reference signal transmissions based on the combined reports.

34. The apparatus according to claim 28, wherein the at least one memory and the computer program code are further configured, with the at least one processor, to cause the apparatus at least to:
determine a quasi-colocation type;
inform, based on the quasi-colocation type, the user equipment that a positioning reference signal transmission of one carrier frequency is nested in a second carrier frequency.

35.-53. (canceled)
